(19) United States
(12) Patent Application Publication
(10) Pub. No.: US 2014/0351041 A1
(43) Pub. Date: Nov. 27, 2014

(54) METHODS OF TRACKING DOWNLOADS AND USAGE OF SOFTWARE APPLICATIONS

(71) Applicant: HasOffers, Inc., (unknown)

(72) Inventors: Lee Brown, Seattle, WA (US); Lucas Brown, Seattle, WA (US)

(21) Appl. No.: 13/902,691

(22) Filed: May 24, 2013

(51) Int. Cl. G06Q 30/02

(52) U.S. Cl. CPC G06Q 30/0246
USPC 705/14.45

(57) ABSTRACT

A method performed by at least one computing device that associates advertisement selections (e.g., clicks) with installations of software applications that are the subject matter of the advertisements. The method includes receiving and storing user click information indicating that a user has selected an advertisement associated with a software application. The user click information comprises first device information and identifies an advertisement provider. The method also includes receiving application installation information indicating that the user has installed the application. The application installation information comprises second device information. The application installation information is matched with the stored user click information based at least in part on the first and second device information. A credit for the installation is assigned to the advertisement provider. The method may also include receiving event information indicating an in-application event has occurred within the application, and assigning a credit for the event to the advertisement provider.

### BACKGROUND OF THE INVENTION

1. Field of the Invention

The present invention is directed generally to methods of tracking application downloads and usage over a network, such as the Internet.

2. Description of the Related Art

Many online advertisers compensate third parties (e.g., advertisement publishers, advertising networks, and the like) who display advertisements to visitors of their websites and/or users of their software applications (e.g., mobile software applications). For example, many advertisers pay such third parties whenever an end user “clicks” on an advertisement. However, such clicks may be accidental or may not otherwise result in a sale of the subject matter of the advertisement.

If the subject matter of the advertisement is a software application, it is particularly useful to know if a user who clicked on the advertisement for the software application also downloaded and installed the software application. It is also useful to know how the end user uses the software application.

Tracking technology may be used to track end user behavior for the purposes of providing compensation to third parties and/or providing analytics to advertisers. Such analytics may be used to target advertising and/or help determine the effectiveness of particular advertising campaigns, advertisement publishers, and/or advertising networks. Unfortunately, currently available methods of tracking downloads, installations, and usage of a software application by a user of a mobile device require the storage of a cookie on the device and/or using JavaScript code to interrogate the user's device. For example, U.S. Patent Publication No. 2012/0278186 describes such a method.

Methods of tracking end user clicks and matching them to subsequent application installations (and usage) that avoid using cookies and/or using JavaScript code to interrogate the user's device are desirable. The present application provides these and other advantages as will be apparent from the following detailed description and accompanying figures.

### BRIEF DESCRIPTION OF THE SEVERAL VIEWS OF THE DRAWING(S)

FIG. 1 is a block diagram of a system configured to track advertisement selections and application installations.

FIG. 2A is a block diagram illustrating a first exemplary flow of information through a portion of the system of FIG. 1.

FIG. 2B is a block diagram illustrating a second exemplary flow of information through a portion of the system of FIG. 1.

FIG. 2C is a block diagram illustrating a third exemplary flow of information through a portion of the system of FIG. 1.

FIG. 2D is a block diagram illustrating a fourth exemplary flow of information through a portion of the system of FIG. 1.

FIG. 3 is a flow diagram of a method of creating an advertisement including a tracking link.

FIG. 4 is a flow diagram of a method of creating the tracking link.

FIG. 5 is a flow diagram of a method of distributing the advertisement including the tracking link.

FIG. 6A is a flow diagram of a method of selecting the advertisement and installing an application associated with the advertisement.

FIG. 6B is a flow diagram of a method of collecting device information when the advertisement is selected.

FIG. 7A is a flow diagram of a method in which an advertisement provider computing device either instructs an end user computing device to open the application associated with the advertisement, or redirects the end user computing device to an application provider from which the application may be downloaded and installed.

FIG. 7B is a flow diagram of a method of recording a user click record.

FIG. 8 is a flow diagram of a method of collecting device information when the application associated with the advertisement is installed and matching at least a portion of the device information with the device information collected when the advertisement was selected.

FIG. 9 is a flow diagram of a method of sending a tracking identifier (and other information) to a tracking system when an in-application event occurs within the installed application.

FIG. 10 is a flow diagram of a method of storing the tracking identifier (and other information) sent to the tracking system when the in-application event occurred within the installed application.

FIG. 11A depicts an exemplary first management interface page configured to request a tracking link and provide the requested tracking link to a customer.

FIG. 11B depicts an exemplary second management interface page configured to display reports.

FIG. 12 is a diagram of hardware and an operating environment in conjunction with which implementations of the computing devices and network of the system of FIGS. 1 and 2A-2D may be practiced.

### DETAILED DESCRIPTION OF THE INVENTION

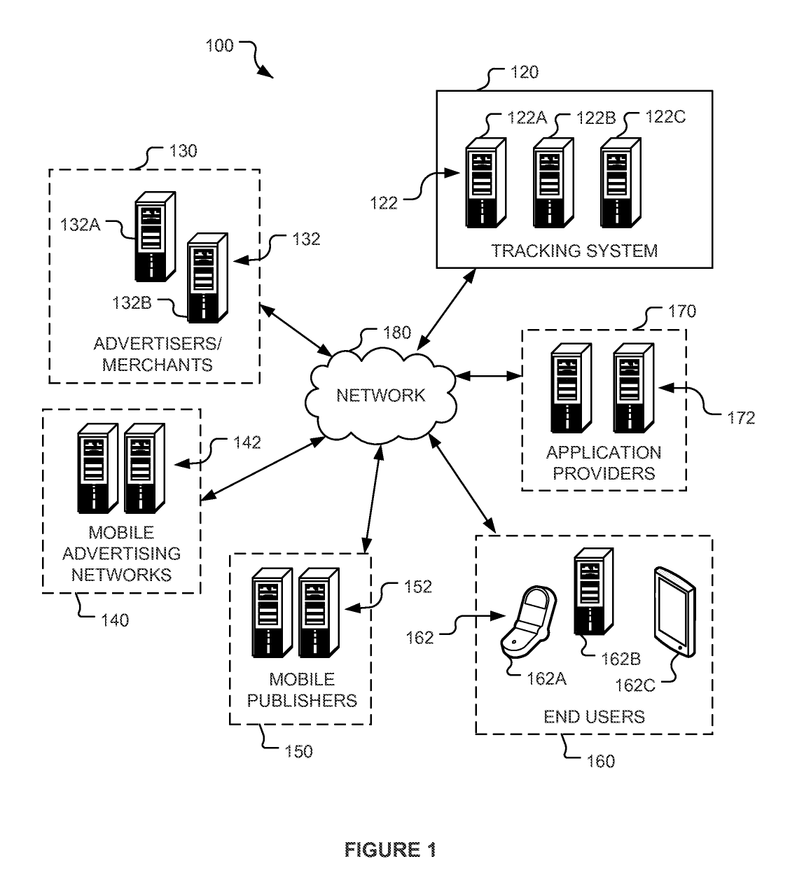

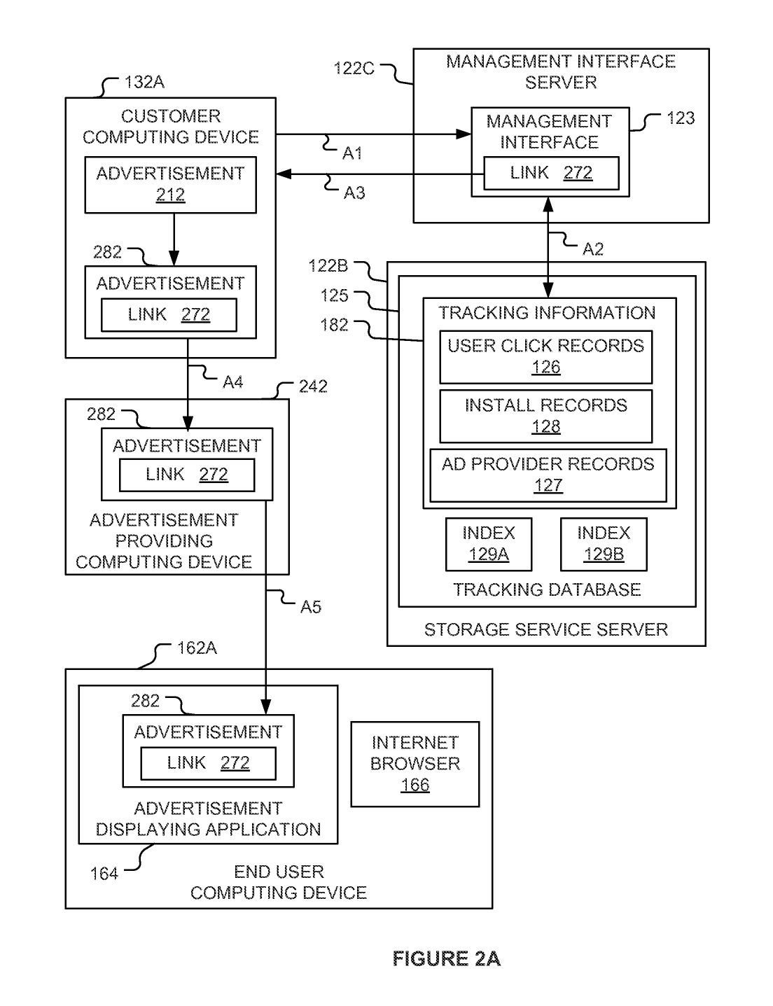

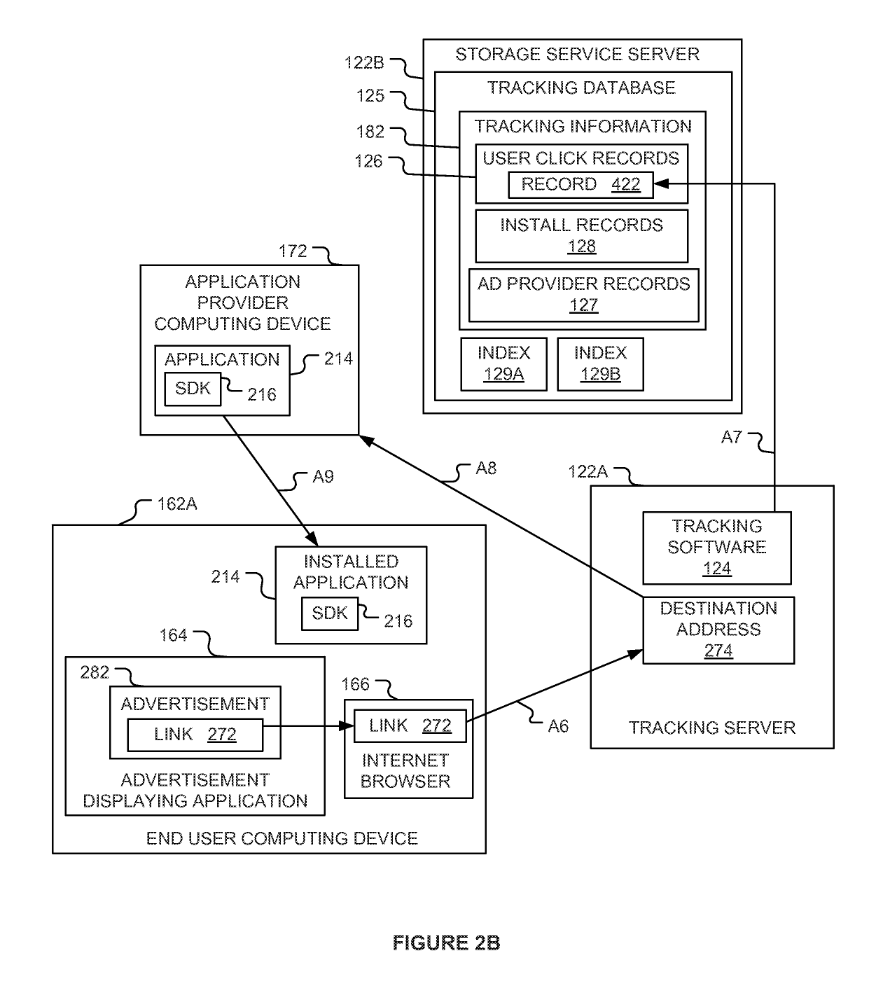

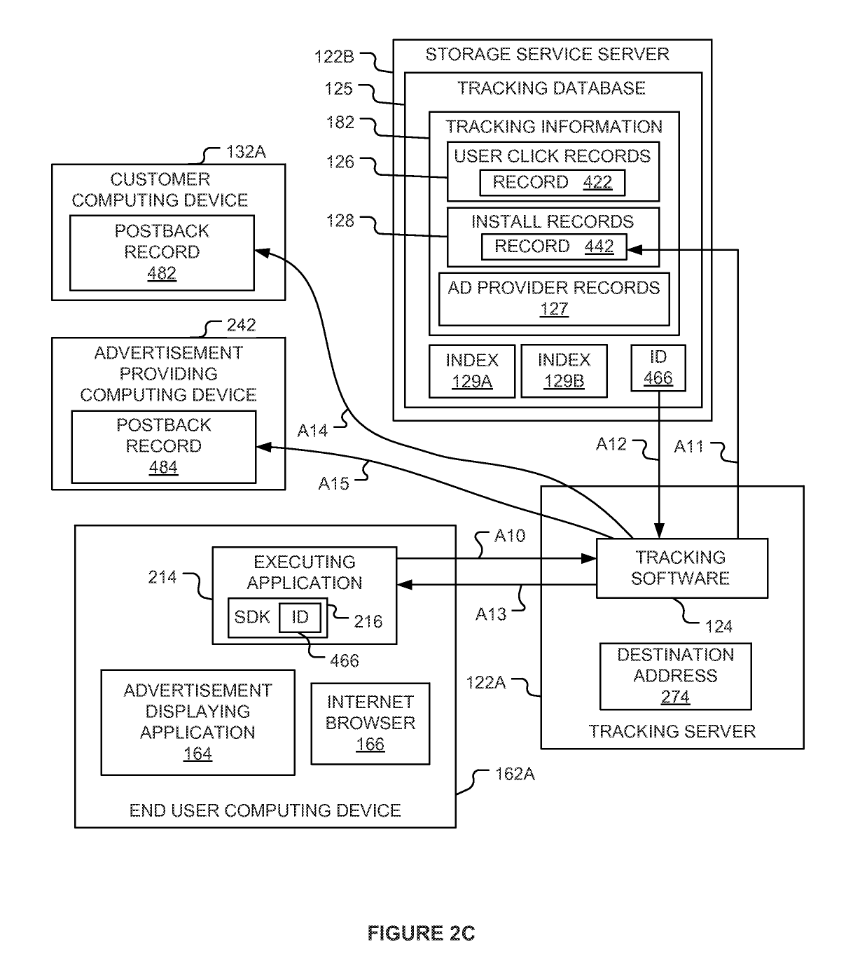

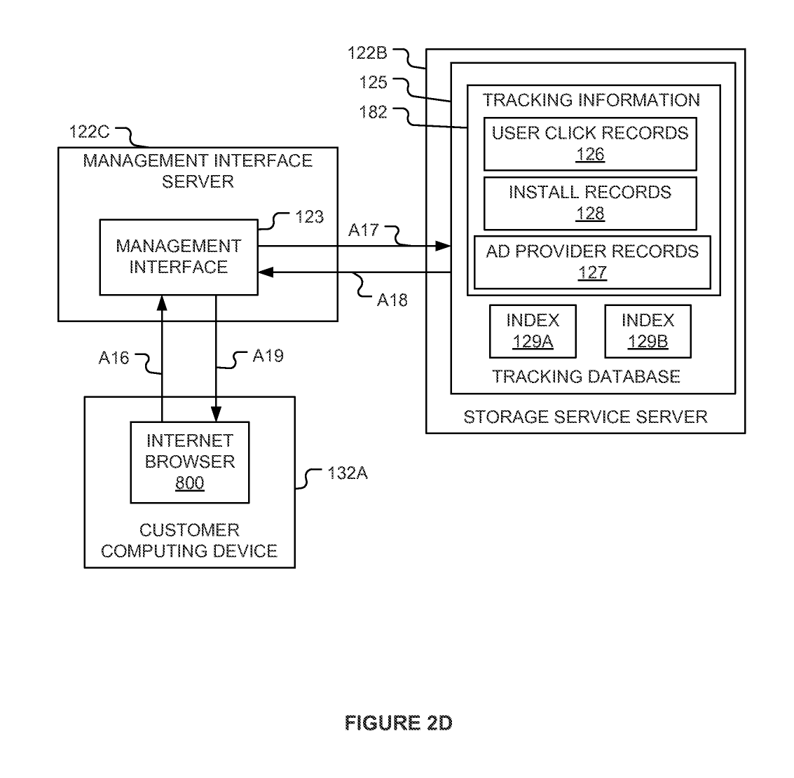

FIG. 1 is a block diagram of an exemplary system 100 configured to match selections of (e.g., clicks on) advertisements with subsequent installations of applications associated with the selected advertisements so that such installations may be attributed to the appropriate party or parties that provided (e.g., distributed and/or displayed) the selected advertisements to those who selected the advertisements and installed the applications. FIGS. 2A-2D are block diagrams that illustrate exemplary flows of information through portions of the system 100.

Turning to FIG. 1, the system 100 includes a tracking system 120. The tracking system 120 includes one or more computing devices 122. In the embodiment illustrated, the computing devices 122 include a tracking server 122A, a storage service server 122B, and a management interface server 122C. In alternate embodiments, the computing devices 122 may include multiple tracking servers, multiple storage service servers, and/or multiple management interface servers. In some embodiments, the storage service server 122B is external to (and optionally remote from) the tracking system 120. In other embodiments, the functionality of the tracking server 122A and the storage service server 122B may be combined on a single computing device (not shown). In some embodiments, the functionality of the tracking server 122A and the management interface server 122C may be combined on a single computing device (not shown). The tracking system 120 is not limited to the use of a particular number of computing devices to implement the functionality of the tracking server 122A, the storage service server 122B, and the management interface server 122C.

Turning to FIG. 2B, the tracking server 122A implements tracking software 124 that communicates with the storage service server 122B.

The storage service server 122B implements a tracking database 125 that stores tracking information 182 received from the tracking server 122A and/or the management interface server 122C (see FIG. 2A). The tracking information 182 includes a plurality of user click records 126, one or more application installation records 128, and one or more application provider records 127.

Each of the user click records 126 includes a site ID value (or a package name value), and device information. Similarly, each of the application installation records 128 includes a site ID value (or a package name value), and device information.

The site ID value and the package name value each identify the application 214 (see FIG. 2B).

The device information includes at least one device identifier and/or other information associated with one of the computing devices 162 (see FIG. 1). The device identifiers may include, but are not limited to, a media access control (“MAC”) Address, an International Mobile Station Equipment Identity (“IMEI”), a Mobile Equipment Identifier (“MEID”), an Identifier for Advertising (“IFA”), an Identifier for Vendor (“IFV”), an Android ID, an Open Device Identification Number (“ODIN”), an Open Unique Device Identifier (“Open UDID”), a device brand, a device model, a combination thereof, and the like. By way of a non-limiting example, the IMEI may be an Andriod IMEI. By way of another non-limiting example, the MEID may be an Andriod MEID. The other information associated with one of the computing devices 162 (see FIG. 1) may include an Internet Protocol (“IP”) Address, browser information (e.g., browser type, browser version, etc.), a combination thereof, and the like. Optionally, all or a portion of the device information may be hashed.

The tracking software 124 may use the tracking database 125 to store the user click records 126, the application installation records 128, and/or the application provider records 127. The tracking database 125 is configured to create indexes (e.g., indexes 129A and 129B). The index 129A indexes the device information in the user click records 126. The index 129B indexes tracking identifiers (discussed below).

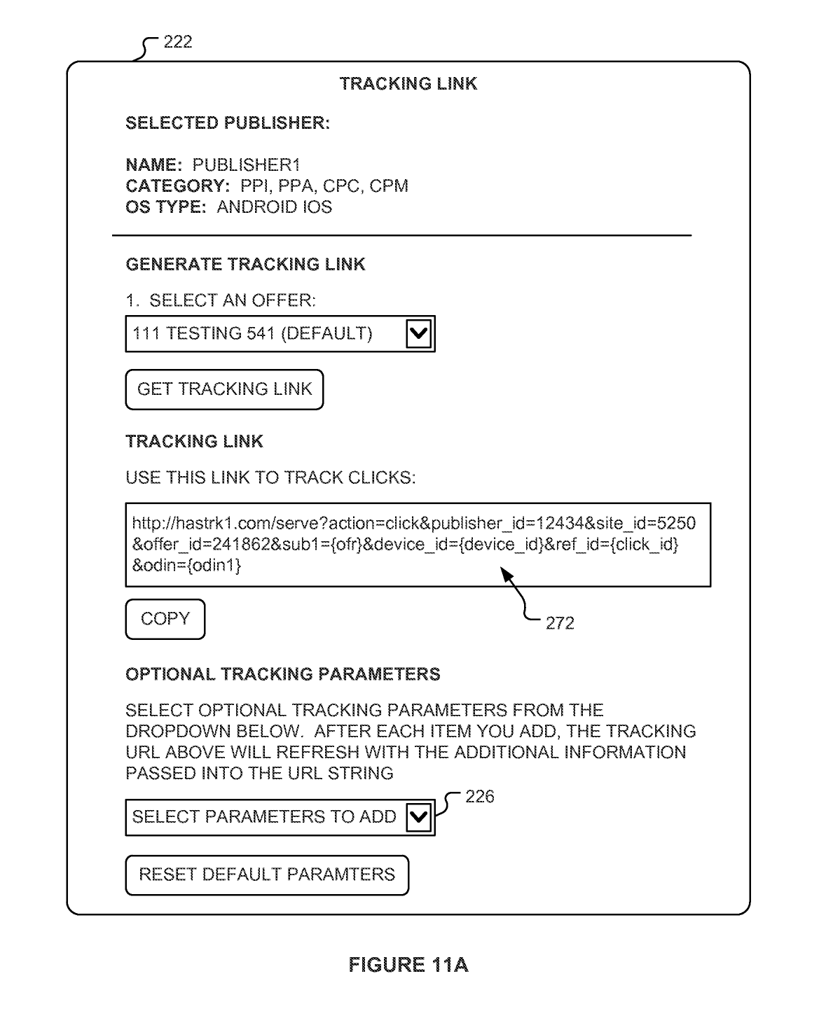

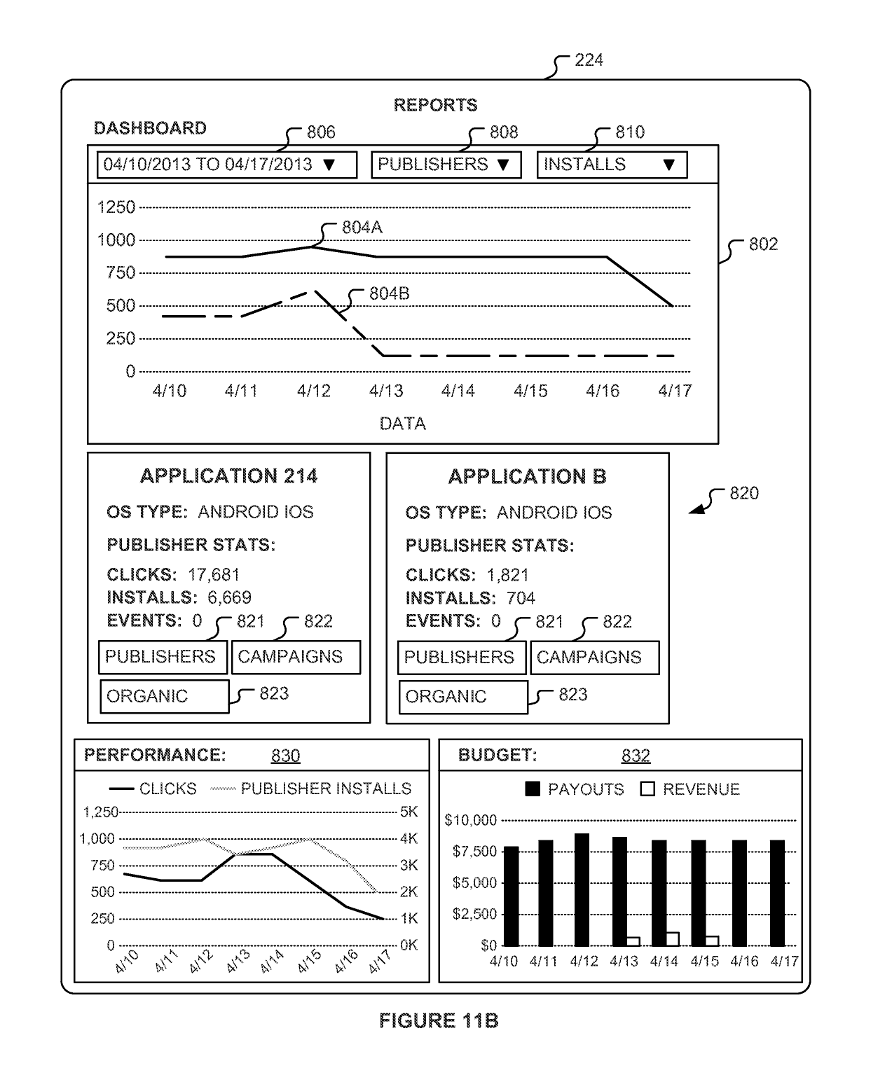

Turning to FIG. 2A, the management interface server 122C includes a management interface module 123 configured to generate a management interface (e.g., a tracking link page 222 illustrated in FIG. 11A and a reports page 224 illustrated in FIG. 11B), described below. The management interface module 123 is configured to access (e.g., via an Application Programming Interface (“API”)) the tracking information 182 stored in the tracking database 125 and use the tracking information 182 to generate displays (e.g., graphs, charts, lists, reports, etc.) for the management interface.

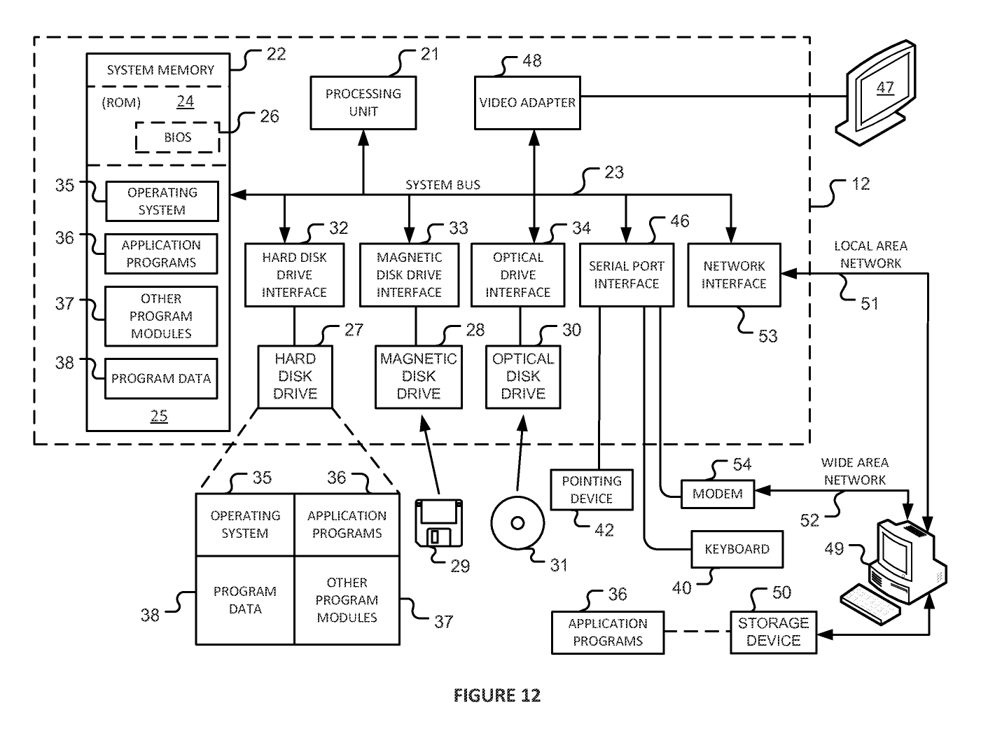

The management interface module 123 may include or communicate with web server components (not shown) configured to transmit conventional webpages displayable by conventional Internet browser applications executing on computing devices, such as a computing device 12 illustrated in FIG. 12 and described below. The management interface may include one or more web pages (e.g., the tracking link page 222 illustrated in FIG. 11A and the reports page 224 illustrated in FIG. 11B) that may be transmitted by the web server components (not shown) to other computing devices in the system 100 (see FIG. 1). Such web pages may be displayed by conventional Internet browser applications executing on the recipient computing devices.

Referring to FIG. 1, the system 100 includes one or more computing devices 132 operated by one or more Advertisers/Merchants 130, one or more computing devices 142 operated by one or more Mobile Advertising Networks 140, one or more computing devices 152 operated by one or more Mobile Publishers 150, a plurality of computing devices 162 operated by a plurality of End Users 160, and one or more computing devices 172 operated by one or more Application Providers 170.

As is apparent to those of ordinary skill in the art, a single entity may function as one of the Advertisers/Merchants 130, one of the Mobile Advertising Networks 140, and one of the Mobile Publishers 150. Such an entity may operate one or more computing devices (not shown) that perform the functions of the computing devices 132, 142, and 152.

The Advertisers/Merchants 130 include companies that wish to advertise products (e.g., software applications) and/or services. As is apparent to those of ordinary skill in the art, to receive some services, the computing devices 162 may be required to install one or more software applications.

The Mobile Advertising Networks 140 include companies that help distribute advertisements for the Advertisers/Merchants 130. Non-limiting examples of such companies include Google, Apple, Millennial Media, Tapjoy, InMobi, Advertising.com, AdColony, Jumptap, Nexage, and the like.

The Mobile Publishers 150 include providers of web sites and mobile applications that display advertisements. Non-limiting examples of such companies include Pandora, Spotify, Facebook, Twitter, Bittorrent.com, The Weather Channel, and any other application or website provider.

The End Users 160 include people who use the computing devices 162 and interact with advertisements, such as those created by the Advertisers/Merchants 130, distributed by the Mobile Advertising Networks 140, and/or displayed by the Mobile Publishers 150. The End Users 160 also use the computing devices 162 to purchase, download, install, and/or interact with applications provided by the Application Providers 170.

The Application Providers 170 include companies that provide installable applications (such as those advertised by the Advertisers/Merchants 130) to the End Users 160. Non-limiting examples of such companies include “app stores,” such as iTunes App Store, Google Play, Amazon Appstore, and the like. The one or more computing devices 172 may be configured to generate a download page (not shown) from which an application may be purchased, downloaded, and/or installed. The download page may be implemented as a webpage.

The computing devices 122, 132, 142, 152, 162, and 172 are connected to one another by a network 180 (e.g., the Internet). Each of the computing devices 122, 132, 142, 152, 162, and 172 may be implemented using the computing device 12 illustrated in FIG. 12 and described below. By way of non-limiting examples, the computing devices 162 have been illustrated as including a cellular telephone 162A, a personal computer 162B (e.g., a desktop computer), and a tablet computer 162C. Each of the computing devices 162 is configured to implement an advertisement displaying application 164 (see FIGS. 2A-2C), such as an Internet browser application 166 (see FIGS. 2A-2C), and/or a different application configured to display advertisements. In FIGS. 2A-2C, the advertisement displaying application 164 is depicted as being different from the Internet browser application 166. However, this is not a requirement. In alternate implementations, the advertisement displaying application 164 is the Internet browser application 166.

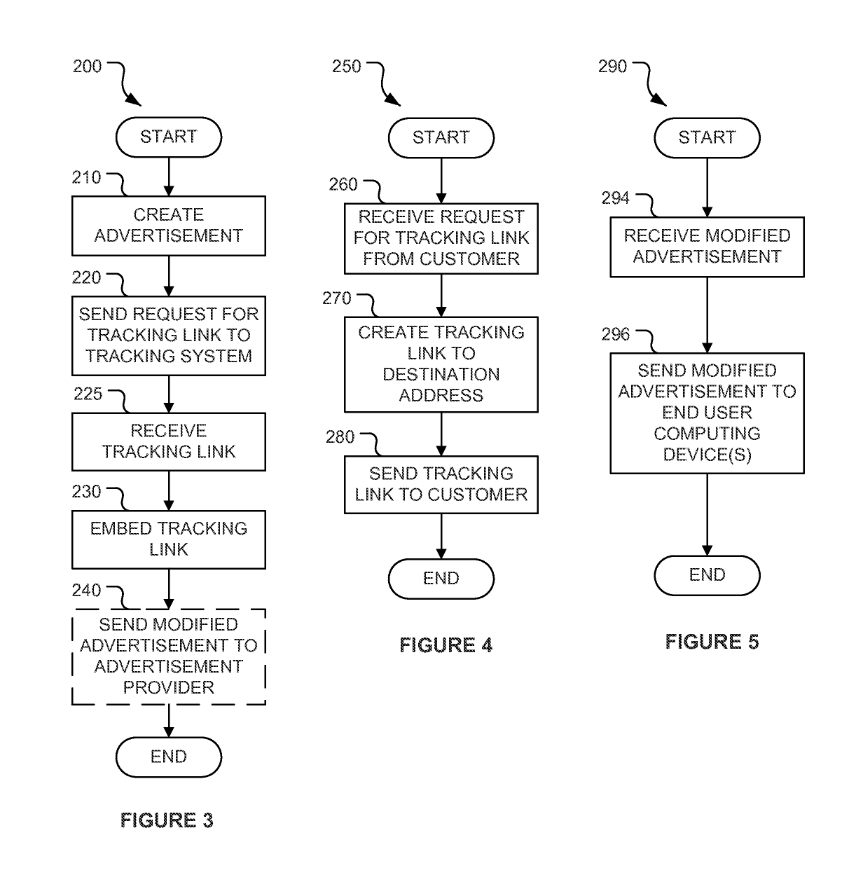

FIGS. 3 and 4 are flow diagrams methods 200 and 250, respectively. The method 200 is performed by one or more computing devices operated by a customer. Referring to FIG. 1, the customer may be one or more of the Advertisers/Merchants 130, the Mobile Advertising Networks 140, and the Mobile Publishers 150. Thus, the method 200 (see FIG. 3) may be performed by one or more of the computing devices 132, 142, and/or 152. For ease of illustration, the method 200 (see FIG. 3) will be described as being performed by the computing device 132A operated by one of the Advertisers/Merchants 130, who in this example, is referred to as the customer.

Turning to FIG. 4, the method 250 is performed by the tracking system 120 (see FIG. 1). For ease of illustration, the method 250 will be described as being performed by the management interface module 123 (see FIG. 2A).

Turning to FIG. 3, in first block 210 of the method 200, the customer creates an advertisement 212 (see FIG. 2A) for display to one or more of the End Users 160 (see FIG. 1) by one or more of the plurality of computing devices 162 (see FIG. 1). Turning to FIG. 2A, the advertisement 212 is configured to be displayed by the advertisement displaying application 164 (e.g., the Internet browser application 166) executing on one or more of the plurality of computing devices 162 (e.g., the computing device 162A). The advertisement 212 is associated with an installable application 214 (see FIG. 2B) available for download on one of the computing devices 172 (see FIG. 2B).

In the embodiment illustrated in FIG. 2B, the application 214 includes a tracking Software Development Kit (“SDK”) 216 that includes functions and/or procedures that execute when selected events occur on the computing device (e.g., the computing device 162A) on which the application 214 is installed. For example, the tracking SDK 216 may include computer-executable instructions that execute when the application 214 is installed and used for the first time. By way of a non-limiting example, the tracking SDK 216 may be implemented as a library file that is included in an application project (not shown) used to create the application 214. An application developer (not shown) may specify which particular functions are called from the library to indicate to the tracking software 124 when install events and/or in-application (“in-app”) events have occurred. The tracking SDK 216 may include a package name value that identifies the application 214.

Returning to FIG. 2A, the advertisement 212 is accessible by the computing device 132A. In FIG. 2A, the advertisement 212 is stored on the computing device 132A. However, this is not a requirement.

Returning to FIG. 3, in block 220, the computing device 132A sends a request for a tracking link 272 to the management interface module 123 via the network 180. In FIG. 2A, this is illustrated by arrow “A1.” By way of a non-limiting example, the management interface may include the tracking link page 222 (see FIG. 11A) into which the customer enters information and requests the tracking link 272. When the customer submits the tracking link page 222, the request is submitted to the management interface module 123.

Turning to FIG. 4, in first block 260 of the method 250, the management interface module 123 receives the request for the tracking link 272 from the customer.

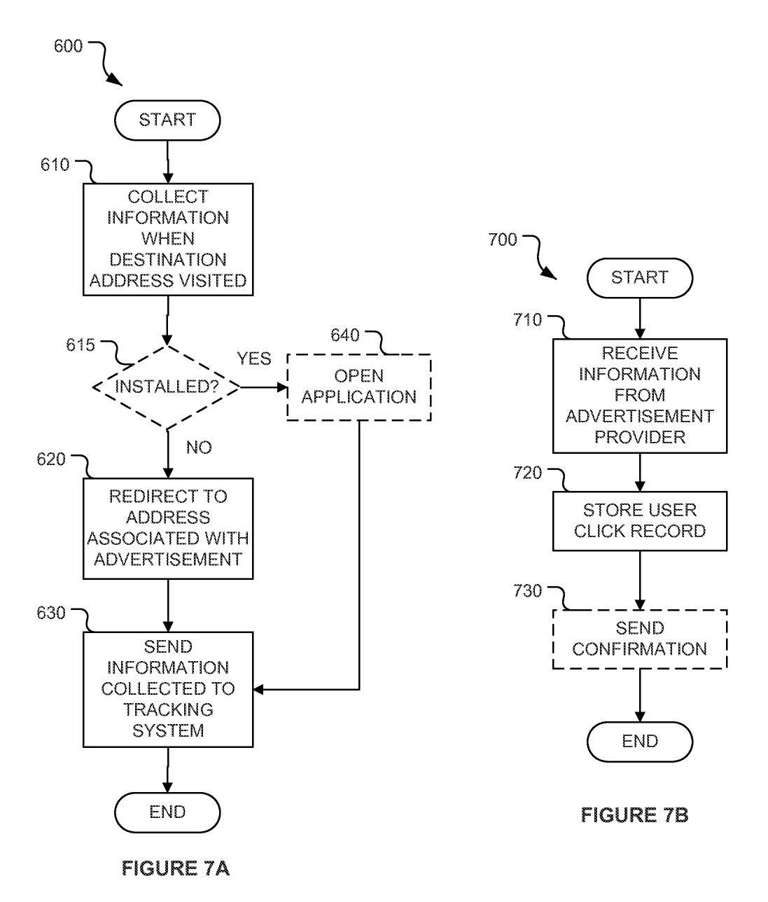

In block 270, the management interface module 123 creates the tracking link 272 (see FIG. 2A) to a destination address 274 (see FIG. 2B). In the embodiment illustrated in FIG. 2B, the destination address 274 is an address on the tracking server 122A. In embodiments in which methods 600 and 700 (see FIGS. 7A and 7B) are performed, the destination address 274 is an address on an advertisement providing computing device 242 (described below). The management interface module 123 may store information (e.g., a campaign ID value (or an offer ID value), a publisher ID value, and a site ID value) in the tracking database 125. Further, the management interface module 123 may use the information (e.g., the campaign ID value (or the offer ID value), the publisher ID value, and the site ID value) stored in the tracking database 125 to create the tracking link 272 in block 270. The transfer of information between the management interface module 123 and the tracking database 125 is illustrated by double-headed arrow “A2.”

The campaign ID value or the offer ID value identifies an advertising campaign and may be used to track the effectiveness of a particular campaign.

The publisher ID value identifies an advertisement provider (e.g., one or more of the Advertisers/Merchants 130, the Mobile Advertising Networks 140, and/or the Mobile Publishers 150) that operates the advertisement providing computing device 242 (see FIG. 2A). The advertisement provider is described in more detail below.

The tracking link 272 may be implemented as a uniform resource locator (“URL”). The customer can request that the tracking link 272 contain various pieces of information, such as a redirect link, one or more macros (e.g., macros that obtain device information (such as the MAC Address, Android ID, and/or IFA), and/or other pieces of information, e.g., the publisher ID, campaign ID, etc.). The destination address 274 and/or the tracking link 272 may be associated with an indicia, such as the site ID and/or the campaign ID. Any or all of these values can be hashed and the hash value included in the tracking link 272 instead of the values themselves.

As mentioned above, the tracking link 272 may include the redirect link. The redirect link may be implemented as an HTTP redirect that sends the computing device 162A to a third-party web page or an application provider web site (e.g., an app store). The tracking link 272 may include the indicia and/or the address to which to redirect the computing devices 162. The tracking database 125 may associate the tracking link 272 with information provided by the customer so the customer may use this information to generate reports using the management interface (e.g., the reports page 224 illustrated in FIG. 11B) generated by the management interface module 123. For example, the customer may have entered a publisher payout amount that may be used to generate a report that shows publisher payout amounts as compared to revenue earned.

The tracking link page 222 illustrates an example of the tracking link 272. In this example, the tracking link 272 is “http://hastrk1.com/serve?action=click&publisherid=12434&site_id=5250&offer_id=241862&sub1={ofr}&device_id={device_id}&ref id={click_id}&odin={odin1}” In this link, the destination address 274 (see FIG. 2B) is “http://hastrk1.com/serve.” The publisher ID is set equal to the value “12434,” which identifies the advertisement provider (e.g., one of the Mobile Publishers 150). The site ID is set equal to the value “5250,” which identifies the application 214. The offer ID is set equal to the value “241862,” which identifies the advertising campaign. Thus, the information stored in the tracking link 272 associates the advertisement with the advertisement provider (e.g., one of the Mobile Publishers 150), the application 214, and the advertising campaign.

As shown in FIG. 11A, the customer may include additional information in the tracking link 272 by using a user input 226 (e.g., a dropdown box) to select additional parameters. When a parameter is selected using the user input 226, the tracking link 272 is automatically modified to include the parameter and, if appropriate, a value assigned to the parameter.

In embodiments in which the methods 600 and 700 (see FIGS. 7A and 7B, respectively) are performed, the destination address 274 is to an address on the advertisement providing computing device 242. In such embodiments, the redirect address may be omitted.

In block 280, the management interface module 123 sends the tracking link 272 to the computing device 132A via the network 180. In FIG. 2A, this is illustrated by arrow “A3.” By way of a non-limiting example, the management interface module 123 may include the tracking link 272 in the tracking link page 222 illustrated in FIG. 11A, which may be displayed in a conventional Internet browser and from which the tracking link 272 can be copied and pasted (e.g., into the advertisement 212) by the customer. Then, the method 250 terminates.

Returning to FIG. 3, in block 225, the computing device 132A receives the tracking link 272. Optionally, referring to FIG. 2A, the customer may modify the tracking link 272 to include one or more macros that execute after the advertisement 214 has been selected (e.g., clicked) by one of the End Users 160 (see FIG. 1). The macros may cause the computing device 162A to dynamically replace the macros with the device information (e.g., at least one device identifier and/or other information) associated with the computing device 162A. Further, the tracking link 272 may be modified to include other data, such as identifiers associated with the customer and/or other parties involved with distributing (e.g., one of the Mobile Advertising Networks 140) or displaying (e.g., one of the Mobile Publishers 150) the advertisement 212 to one of the End Users 160.

In block 230 shown in FIG. 3, referring to FIG. 2A, the computing device 132A embeds the tracking link 272 in the advertisement 212 to create a modified advertisement 282.

At this point, the modified advertisement 282 is ready to be sent (e.g., pushed) to one or more of the computing devices 162.

In optional block 240 shown in FIG. 3, referring to FIG. 2A, the computing device 132A sends the modified advertisement 282 to the advertisement providing computing device 242 via the network 180. In FIG. 2A, this is illustrated by arrow “A4.” The advertisement providing computing device 242 is operated by the advertisement provider, which may include one or more of the Advertisers/Merchants 130, the Mobile Advertising Networks 140, and/or the Mobile Publishers 150. Thus, the advertisement providing computing device 242 may be one or more of the computing devices 132, 142, and/or 152. The advertisement provider may be the same as or different from the customer. In embodiments in which the advertisement provider is the same as the customer, optional block 240 may be omitted.

Then, the method 200 terminates.

FIG. 5 is a flow diagram of a method 290 performed by the advertisement providing computing device 242 (see FIG. 2A) operated by the advertisement provider, which (as mentioned above) may include one or more of the Advertisers/Merchants 130, the Mobile Advertising Networks 140, and/or the Mobile Publishers 150.

In block 294, the advertisement providing computing device 242 receives the modified advertisement 282 from the computing device 132A. In embodiments in which the advertisement provider is the same as the customer, block 294 may be omitted.

Then, in block 296, the advertisement providing computing device 242 (e.g., one of the computing devices 152) sends (e.g., pushes) the modified advertisement 282 to one or more of the plurality of computing devices 162 via the network 180. For ease of illustration, in FIG. 2A, the modified advertisement 282 is pushed to the computing device 162A. In FIG. 2A, this is illustrated by arrow “A5.” Then, the method 290 terminates.

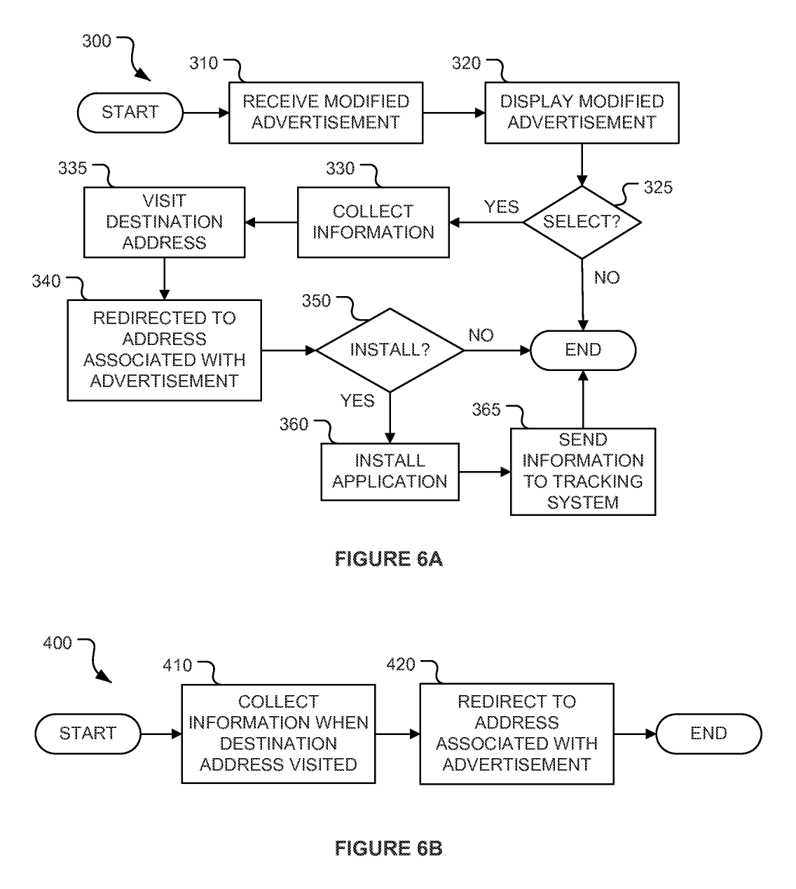

FIGS. 6A and 6B are flow diagrams of methods 300 and 400, respectively. The method 300 is performed by one of the computing devices 162 operated by the end Users 160. Thus, the method 300 may be performed by one or more of the computing devices 162A, 162B, or 162C. For ease of illustration, the method 300 will be described as being performed by the computing device 162A. The method 400 is performed by the tracking system 120. For ease of illustration, the method 400 will be described as being performed by the tracking software 124 executing on the tracking server 122A. However, as is apparent to those of ordinary skill in the art, portions of the method 400 may be performed by the tracking database 125 (see FIGS. 2A-2D) and/or the tracking software 124 working together with the tracking database 125.

Turning to FIG. 6A, in first block 310 of the method 300, the computing device 162A receives the modified advertisement 282 pushed to the computing device 162A by the advertisement providing computing device 242.

In block 320, the advertisement displaying application 164 (see FIG. 2B) executing on the computing device 162A displays the modified advertisement 282 to the end user operating the computing device 162A.

The end user may select (e.g., click on) the modified advertisement 282 using a user interface of the computing device 162A. When this occurs, the computing device 162A receives the user selection via the user interface.

In decision block 325, the computing device 162A determines whether the end user has selected the modified advertisement 282. The decision in decision block 325 is “YES” when the end user has selected the modified advertisement 282. On the other hand, the decision in decision block 325 is “NO” if the end user does not select the modified advertisement 282.

When the decision in decision block 325 is “NO,” the method 300 terminates.

When the decision in decision block 325 is “YES,” in block 330, the computing device 162A collects the device information (e.g., the IFA, the Android ID, the MAC address, the IP address, browser information, and the like) associated with the computing device 162A, and stores that information in the tracking link 272. As mentioned above, the tracking link 272 may include macros that instruct the computing device 162A to collect the device information associated with the computing device 162A, and store that information in the tracking link 272. In some embodiments, the advertisement displaying application 164 may collect the information about the computing device 162A.

Then, the tracking link 272 causes the computing device 162A to go to the destination address 274 (which, in this example, is on the tracking server 122A). In FIG. 2B, this is illustrated by arrow “A6.” In the embodiment illustrated, the tracking link 272 causes the computing device 162A to use the Internet browser application 166 to visit the destination address 274. In such embodiments, the Internet browser application 166 may collect the information about the computing device 162A.

Turning to FIG. 6B, in first block 410 of the method 400, the tracking software 124 executing on the tracking server 122A collects the information stored in the tracking link 272 and/or obtains information from the HTTP header received by the tracking server 122A. For example, the HTTP header may include the IP address and browser information by default. The tracking software 124 stores the information received in the tracking link 272 and/or obtained from the HTTP header as a single user click record 422 (see FIG. 2B) in the user click records 126 stored in the tracking database 125. In FIG. 2B, this is illustrated by arrow “A7.” By way of a non-limiting example, the device information associated with the computing device 162A stored in the user click record 422 (see FIG. 2B) may include the user's MAC address, IP address, and browser information.

The tracking software 124 may also credit the appropriate party or parties (e.g., the advertisement provider associated with the advertisement providing computing device 242) for the user click. The party or parties credited may be identified in the tracking link 272. By way of a non-limiting example, a “credit” may be stored in the tracking information 182 stored on the storage service server 122B. For example, the advertisement provider records 127 may be updated to reflect the “credit” earned by the advertisement provider associated with the advertisement providing computing device 242.

As mentioned above, the tracking link 272 may include the indicia associated with the address (and/or the address itself) to which to redirect the computing devices 162. The address is an address of one of the Application Providers 170 from which the installable application 214 may be purchased, downloaded, and/or installed. In block 420 in FIG. 6B, the tracking software 124 redirects the computing device 162A to the address whereat the installable application 214 may be purchased, downloaded, and/or installed. In FIG. 2B, this is illustrated by arrow “A8.” By way of a non-limiting example, in block 420, the tracking software 124 may issue an HTTP redirect to the Internet browser application 166.

Then, the method 400 terminates.

Returning to FIG. 6A, after the method 400 has been performed, the end user may decide to install the application 214. However, this decision need not be made immediately following the redirect and could be made at a much later time.

In decision block 350, the computing device 162A determines whether the end user has decided to install the application 214. The decision in decision block 350 is “YES” when the end user has decided to install the application 214 and executes it for the first time. The end user may use the user interface of the computing device 162A to indicate to the computing device 162A that the end user wishes to install and use the application 214. On the other hand, the decision in decision block 350 is “NO” if the end user decides not to install the application 214.

When the decision in decision block 350 is “NO,” the method 300 terminates.

When the decision in decision block 350 is “YES,” in block 360, the computing device 162A downloads and installs the application 214. In FIG. 2B, this is illustrated by arrow “A9.” The end user may use the user interface of the computing device 162A to purchase, download, and/or install the application 214 in block 360. When this occurs, the computing device 162A receives user instructions via the user interface and in response thereto, downloads, and installs the application 214.

As mentioned above, the application 214 includes the tracking SDK 216. When the installed application 214 is first used, in block 365, the tracking SDK 216 causes the computing device 162A to automatically obtain device information associated with the computing device 162A and send that information to the tracking software 124 (e.g., with a “log” request). In FIG. 2C, this is illustrated by arrow “A10.” By way of a non-limiting example, the tracking SDK 216 may include one or more functions that the application developer coded into the application 214 that execute when one or more selected events occurs (e.g., an install call). For example, in block 365, the tracking SDK 216 may collect the device information associated with the computing device 162A, and send an http request to the tracking server 122A that includes the information collected. The request may optionally include the package name value that identifies the installed application 214. Block 365 may occur in the background of the computing device 162A and may not alter the end user's visual experience.

Then, the method 300 terminates.

In alternate embodiments, when the method 300 (see FIG. 5) is performed, the methods 600 and 700 (see FIGS. 7A and 7B, respectively) may be performed instead of the method 400 illustrated in FIG. 6B. FIGS. 7A and 7B are flow diagrams of the methods 600 and 700, respectively. The methods 600 and 700 are performed when the destination address 274 is on the advertisement providing computing device 242 (instead of on the tracking server 122A). These methods may be characterized as enabling loading tracking links server-side. When the methods 600 and 700 are performed, the computing device 162A does not visit the tracking server 122A before being redirected to one of the computing devices 172. Instead, the advertisement providing computing device 242 redirects the computing device 162A to one of the computing devices 172.

The method 600 is performed by the advertisement providing computing device 242. The method 700 is performed by the tracking system 120. For ease of illustration, the method 700 will be described as being performed by the tracking software 124 executing on the tracking server 122A. However, as is apparent to those of ordinary skill in the art, portions of the method 700 may be performed by the tracking database 125 (see FIGS. 2A-2D) and/or the tracking software 124 working together with the tracking database 125.

After the computing device 162A visits the destination address 274 on the advertisement providing computing device 242 in block 335 of the method 300 illustrated in FIG. 6A, the advertisement providing computing device 242 performs first block 610 of the method 600 illustrated in FIG. 7A.

In first block 610, the advertisement providing computing device 242 collects the information stored in the tracking link 272 and/or obtains information from the HTTP header received by the advertisement providing computing device 242.

In optional decision block 615, the advertisement providing computing device 242 determines whether the application 214 is already installed on the computing device 162A. By way of a non-limiting example, the advertisement providing computing device 242 may store or have access to records tracking which applications have been installed by at least some of the computing devices 162. For example, the advertisement providing computing device 242 may query the tracking database 125 via the management interface module 123 to determine whether the application 214 is already installed on the computing device 162A.

The decision in optional decision block 615 is “YES” when the advertisement providing computing device 242 determines the application 214 is installed on the computing device 162A. On the other hand, the decision in optional decision block 615 is “NO” when the advertisement providing computing device 242 determines the application 214 is not installed on the computing device 162A.

When the decision in optional decision block 615 is “NO,” or the optional decision block 615 has been omitted, the advertisement providing computing device 242 advances to block 620. In block 620, the advertisement providing computing device 242 redirects the computing device 162A to the address whereat the installable application 214 may be purchased, downloaded, and/or installed. By way of a non-limiting example, in block 620, the advertisement providing computing device 242 may issue an HTTP redirect to the Internet browser application 166. After block 620, the advertisement providing computing device 242 advances to block 630, and block 340 of the method 300 illustrated in FIG. 6A may be performed by the computing device 162A.

Returning to FIG. 7A, when the decision in optional decision block 615 is “YES,” the advertisement providing computing device 242 advances to optional block 640. In optional block 640, the advertisement providing computing device 242 directs the computing device 162A to open the application 214. Conventional methods of directing the application displaying application 164 (e.g., the Internet browser application 166) to open the application 214 may be used in optional block 640. After optional block 640, the advertisement providing computing device 242 advances to block 630. In embodiments in which the optional block 640 has been omitted, when the decision in optional decision block 615 is “YES,” the advertisement providing computing device 242 advances to block 630.

In block 630, the advertisement providing computing device 242 sends at least a portion of the information collected in block 610 to the tracking system 120 (e.g., the tracking server 122A) so the tracking system 120 may record a user click record. Then, the method 600 terminates.

Turning to FIG. 7B, in first block 710, the tracking software 124 recieves the information sent by the advertisement providing computing device 242 in block 630 of the method 600 illustrated in FIG. 7A.

Returning to FIG. 7B, in block 720, the tracking software 124 stores at least a portion of the information received in block 710 in the user click records 126 stored in the tracking database 125. By way of a non-limiting example, the information received in block 710, and stored in the user click record 422 (see FIG. 2B) may include the site ID value, user's MAC address value, IP address value, and browser information.

The tracking software 124 may also credit the appropriate party or parties (e.g., the advertisement provider associated with the advertisement providing computing device 242) for the user click. The party or parties credited may be identified in the information received in block 710. By way of a non-limiting example, a “credit” may be stored in the tracking information 182 stored on the storage service server 122B. For example, the advertisement provider records 127 may be updated to reflect the “credit” earned by the advertisement provider associated with the advertisement providing computing device 242.

Then, in optional block 730, the tracking software 124 may send a confirmation or acknowledgement to the advertisement providing computing device 242 indicating that the tracking software 124 received the information sent by the advertisement providing computing device 242 in block 630 of the method 600 illustrated in FIG. 7A. In the embodiment illustrated, block 720 is performed before block 730. In alternate embodiments, block 730 may be performed before block 720.

Then, the method 700 terminates.

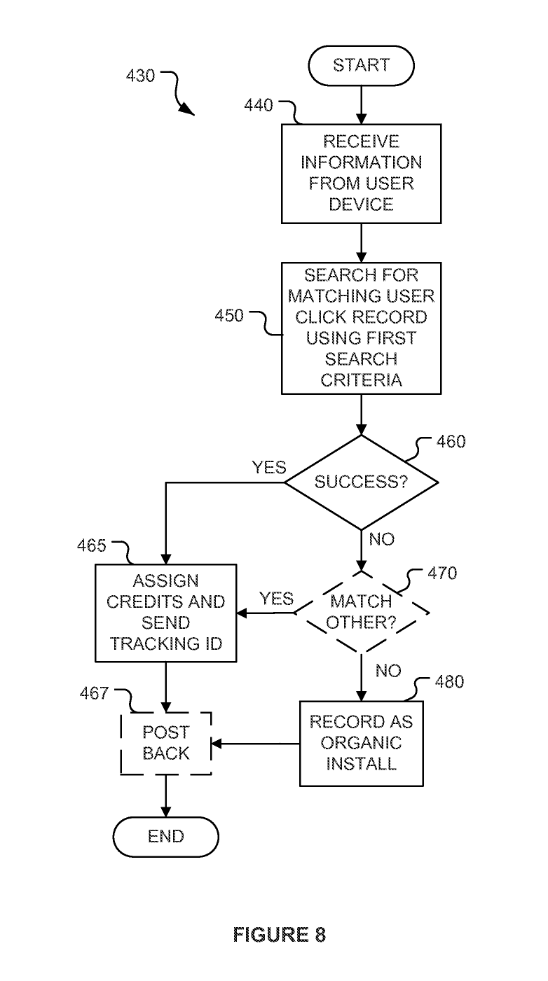

FIG. 8 is a flow diagram of a methods 430 performed by the tracking system 120. For ease of illustration, the method 430 will be described as being performed by the tracking software 124 executing on the tracking server 122A. However, as is apparent to those of ordinary skill in the art, portions of the method 430 may be performed by the tracking database 125 (see FIGS. 2A-2D) and/or the tracking software 124 working together with the tracking database 125.

Turning to FIG. 8, in first block 440 of the method 430, the tracking software 124 receives the information sent by the tracking SDK 216 in block 365 of the method 300 illustrated in FIG. 6A. The information received may be stored in an application installation record 442 in the application installation records 128 depicted in FIG. 2C.

Returning to FIG. 8, in block 450, the tracking software 124 attempts to match the application installation record 442 with the information previously stored in one of the user click records 126 using first search criteria.

For example, the first search criteria may specify that the IFA values and the site ID values must match. The first search criteria may also include a predetermined “lookback” period (e.g., seven days). In this example, if the tracking software 124 received the IFA value “703122b3-c066-40fc-859f-d5a8d4373c6c” and a particular site ID value from the tracking SDK 216 (in block 440), in block 450, the tracking software 124 will attempt to find a user click record in the user click records 126 that includes the same IFA and site ID values. For ease of illustration, the user click record 422 includes the IFA value “703122b3-c066-40fc-859f-d5a8d4373c6c,” and the particular site ID value. In this example, the tracking software 124 would locate the user click record 422 because it includes the IFA value “703122b3-c066-40fc-859f-d5a8d4373c6c,” and the particular site ID value. Then, the tracking software 124 determines whether the user click record 422 was created within the predetermined “lookback” period. If the user click record 422 was created within the predetermined “lookback” period, the tracking software 124 has successfully located a matching click record. If the user click record 422 was not created within the predetermined “lookback” period, the tracking software 124 has failed to located a matching click record.

By way of another non-limiting example, the first search criteria may specify that the IFA values and the package name values must match. In such embodiments, the package name value is used instead of the site ID value. Further, the first search criteria may also include a predetermined “lookback” period (e.g., seven days).

In decision block 460, the tracking software 124 determines whether the search conducted in block 450 using the first search criteria was successful. The decision in decision block 460 is “YES” when the search conducted in block 450 was successful. For example, the decision in decision block 460 is “YES” when the tracking software 124 locates a matching user click record created within the predetermined “lookback” period. On the other hand, the decision in decision block 460 is “NO” when the search conducted in block 450 was unsuccessful.

When the decision in decision block 460 is “YES,” in block 465, the tracking software 124 records a conversion (from a click to an install) and credits the advertisement 212 (see FIG. 2A) and advertisement provider (identified in the tracking link 272 and stored in the user click record 422) that led to the installation. The tracking software 124 may store this information in the tracking information 182 stored in the tracking database 125. For example, the advertisement provider records 127 may be updated to reflect the “credit” earned by the advertisement provider associated with the advertisement providing computing device 242.

Optionally, the tracking database 125 generates a tracking identifier 466 and sends the tracking identifier 466 to the tracking software 124. In FIG. 2C, this is illustrated by arrow “A12.” Then, the tracking software 124 sends the tracking identifier 466 (see FIG. 2C) to the tracking SDK 216. In FIG. 2C, this is illustrated by arrow “A13.”

Returning to FIG. 8, then, the tracking software 124 may advance to optional block 467. In embodiments that omit the optional block 467, the method 430 terminates after the block 467.

In optional block 467, the tracking software 124 may send a “server postback” to one or more of the Advertisers/Merchants 130, the Mobile Advertising Networks 140, and/or the Mobile Publishers 150 that includes the information recorded on the tracking server 122A and/or the storage service server 122B. For example, the server postback may include the information stored in the application installation record 442 and matching user click record 422. In FIG. 2C, arrow “A14” depicts server postback 482 to the customer, and arrow “A15” depicts server postback 484 to the advertisement provider. Each of the server postbacks 482 and 484 provides a copy of at least a portion of the information recorded on the tracking server 122A and/or the storage service server 1228 that the recipient can use for a variety of purposes. Then, the method 430 terminates.

When the decision in decision block 460 is “NO,” the tracking software 124 may advance to optional decision block 470. In embodiments in which optional decision block 470 is omitted, the tracking software 124 advances to block 480.

In optional decision block 470, the tracking software 124 tries to locate a matching user click record (for the application installation record 442) using different second search criteria than that used in block 450. For example, the tracking software 124 may try to match the site ID (or the package name), IP address, device brand, and device model values received from the tracking SDK 216 (in block 440) with information stored in the user click records 126. The second search criteria may also include a predetermined “lookback” period (e.g., twenty-four hours).

The decision in optional decision block 470 is “YES” when the tracking software 124 locates a user click record using the second search criteria. For example, the decision in optional decision block 470 is “YES” when the tracking software 124 locates a matching user click record created within the predetermined “lookback” period. When the decision in optional decision block 470 is “YES,” the tracking software 124 advances to block 465.

On the other hand, the decision in optional decision block 470 is “NO” when the tracking software 124 fails to locate a user click record using the second search criteria. When the decision in optional decision block 470 is “NO,” in block 480, the tracking software 124 records the installation as an “organic install” (e.g., in the tracking information 182 stored on the storage service server 122B). Then, the tracking software 124 advances to optional block 467. If optional block 467 is omitted, the method 430 terminates after block 480.

To make searching and matching more efficient, the device information associated with the computing devices 162 (e.g., the IP address values, IFA values, Open UDID values, and the like) may be indexed (e.g., the index 129B) by the storage engine 125. The tracking software 124 may use the index 1298 when searching for a match in block 450 and/or optional decision block 470.

If more than one match is located in block 450 and/or optional decision block 470, the tracking software 124 may select the most-recently recorded user click record.

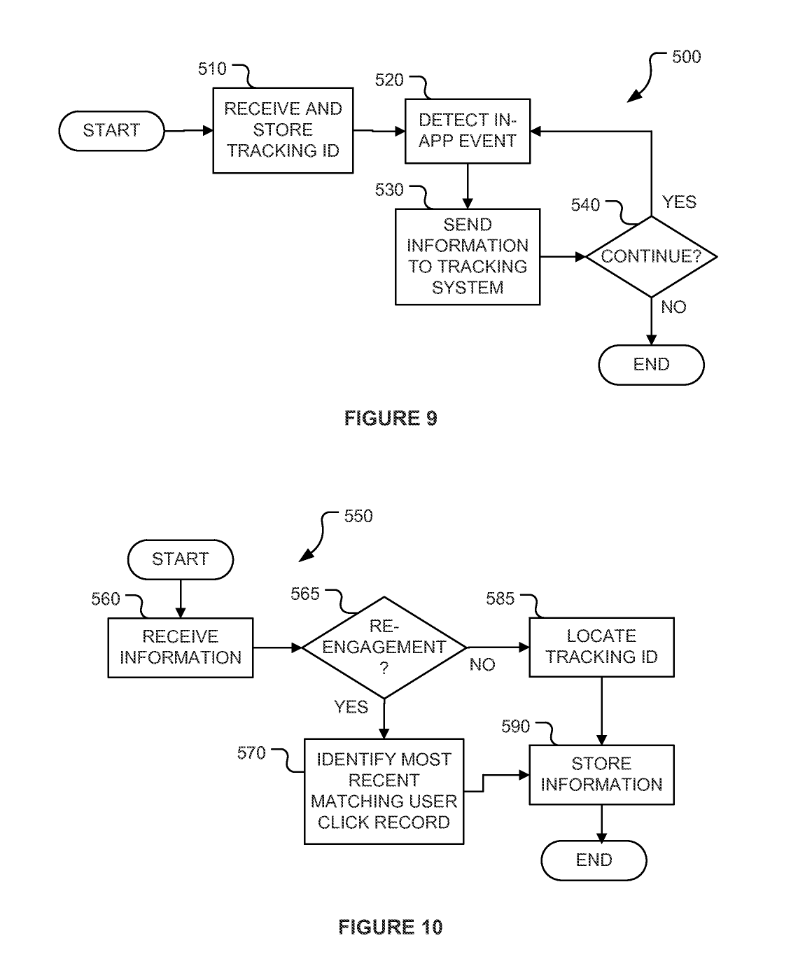

FIG. 9 is a flow diagram of a method 500 performed by one of the computing devices 162. For ease of illustration, the method 500 will be described as being performed by the computing device 162A.

Referring to FIG. 9, in first block 510, the tracking SDK 216 executing on the computing device 162A receives the tracking identifier 466 (see FIG. 2C) via the network 180 from the tracking software 124 executing on the tracking server 122A. The tracking SDK 216 stores the tracking identifier 466 for subsequent use.

In block 520, the tracking SDK 216 detects an in-app event has occurred. As mentioned above, the application developer may specify that particular functions and/or procedures are executed whenever one or more selected events occurs. Non-limiting examples of in-app events include level-ups, purchases, user clicks, and registrations.

In block 530, the tracking SDK 216 sends information to the tracking server 122A. The information includes the tracking identifier 466. Optionally, the information may include a purchase price or other revenue information (e.g., if the triggering in-app event was a purchase or other revenue generating event). By way of another non-limiting example, the information may include an indication of whether re-engagement has been enabled for the triggering in-app event. Optionally, the information may include the site ID value or the package name value (to identify the application 214) and the device information that may be used to locate a matching user click record stored for the computing device 162A and the application 214. The tracking SDK 216 may identify for which in-app events re-engagement has been enabled.

In decision block 540, the tracking SDK 216 decides whether to continue monitoring for the occurrence of in-app events. The decision in decision block 540 is “YES,” when the tracking SDK 216 decides to continue monitoring for the occurrence of in-app events. On the other hand, decision in decision block 540 is “NO,” when the tracking SDK 216 decides not to continue monitoring for the occurrence of in-app events. By way of a non-limiting example, the decision in decision block 540 is “YES” as long as the application 212 is executing. Otherwise, the decision in decision block 540 is “NO.”

When the decision in decision block 540 is “YES,” the tracking SDK 216 returns to block 520. On the other hand, when the decision in decision block 540 is “NO,” the method 500 terminates.

FIG. 10 is a flow diagram of a method 550 performed by the tracking system 120. For ease of illustration, the method 500 will be described as being performed by the tracking software 124 executing on the tracking server 122A.

In first block 560, the tracking software 124 receives the information sent by the tracking SDK 216 in block 530 of the method 500 illustrated in FIG. 9. The information includes the tracking identifier 466 (see FIG. 2C).

In decision block 565, the tracking software 124 determines whether re-engagement has been enabled. If re-engagement is not enabled, future in-app events are attributed (or credited) to the same advertisement provider who was credited with the end user having installed the application 214. On the other hand, if re-engagement is enabled, post-install in-app events are credited to the advertisement provider who most recently interacted with the end user. This may be useful when the end user installed the application 214 several months ago, and the advertisement provider would like compensation for getting the end user to re-open the application 214 and complete an action or event, such as an in-app purchase. Thus, those advertisement providers who cause end users to re-engage with the application 214 receive credits for such re-engagement. Re-engagement may be particularly useful for applications that are typically used infrequently. An indication of whether re-engagement has been enabled may be included in the information received in block 560.

The decision in decision block 565 is “YES” when re-engagement has been enabled. On the other hand, the decision in decision block 565 is “NO” when re-engagement has not been enabled.

When the decision in decision block 565 is “NO,” the tracking software 124 advances to block 585. In block 585, the tracking software 124 uses the tracking identifier 466 (and optionally the index 1298) to identify the application installation record 442 associated with the computing device 162A and the application 212, and the user click record 422 matched with the application installation record 442.

Then, in block 590, the tracking software 124 stores the information received in block 560 and associates it with the application installation record 442 and the user click record 422. Optionally, the tracking software 124 may store this information on the storage service server 122B accessible by the management interface module 123. For example, the advertisement provider records 127 may be updated to reflect a “credit” earned (for the in-app event) by the advertisement provider associated with the advertisement providing computing device 242.

When the decision in decision block 565 is “YES,” the tracking software 124 advances to block 570. In block 570, the tracking software 124 matches the information received in block 560 with the information previously stored in one of the user click records 126. For example, the tracking software 124 may search for the most recently recorded user click record using a third search criteria (e.g., matching IFA and site ID values). For ease of illustration, in block 570, the user click record 422 is identified as the most recently recorded user.

Then, the method 550 terminates.

Turning to FIG. 2D, the management interface (e.g., the reports page 224 illustrated in FIG. 11B) generated by the management interface module 123 may be used to view portions of the tracking information 182 and generate reports based at least in part on the tracking information 182 stored in the tracking database 125 on the storage service server 122B. One or more of the Advertisers/Merchants 130, the Mobile Advertising Networks 140, and/or the Mobile Publishers 150 may use the management interface (e.g., the reports page 224 illustrated in FIG. 11B) generated by the management interface module 123 to generate reports. For ease of illustration, in FIG. 2D, the computing device 132A operated by the customer is illustrated using the management interface to generate the reports page 124 illustrated in FIG. 11B.

In the embodiment illustrated in FIG. 2D, the computing device 132A executes a conventional Internet browser application 800. The Internet browser application 800 displays webpages generated by the management interface module 123 and transmits user input received from the end user to the management interface module 123.

In FIG. 2D, an arrow “A16” represents a request sent by the Internet browser application 800 (in response to a user instruction received via a user interface) to the management interface module 123 for the reports page 224.

When the management interface module 123 receives the request, the management interface module 123 sends a request to the tracking database 125 for the information necessary to generate the reports page 224. This request is represented in FIG. 2D by arrow “A17.”

In response to the request sent by the management interface module 123, the tracking database 125 obtains the information requested and sends the information to the management interface module 123. This request is represented in FIG. 2D by arrow “A18.”

After the management interface module 123 receives the information from the tracking database 125, the management interface module 123 generates the reports page 224 and sends it to the Internet browser application 800 for display thereby to the end user. This request is represented in FIG. 2D by arrow “A19.”

By way of non-limiting examples, the management interface module 123 may allow the Advertisers/Merchants 130, the Mobile Advertising Networks 140, and/or the Mobile Publishers 150 to access one or more of the following types of information:

1. User Click Data;

2. User Install Data;

3. User Event Data;

4. Publisher Payouts;

5. Install Rate;

6. Cost Per Click;

7. Revenue Per Install; and

8. Other Relevant Information.

Depending upon the implementation details, the management interface module 123 may be used to aggregate information and provide analytics (e.g., graphs) to the Advertisers/Merchants 130, the Mobile Advertising Networks 140, and/or the Mobile Publishers 150 that may be used thereby to improve the effectiveness of advertising campaigns.

The storage service server 122B may organize and index the tracking information 182. Optionally, the storage service server 122B may include a storage engine (not shown) substantially similar to the storage engine 125 executing on the tracking server 122A.

FIG. 11B is an illustration of the exemplary reports page 224 generated by the management interface module 123. The reports page 224 includes a graph 802. Each line (e.g., lines 804A and 804B) on the graph 802 depicts data for a select application (e.g., the application 214). For ease of illustration, in FIG. 11B, the graph 802 includes the line 804A, which depicts data for the application 214, and the line 804B, which depicts data for a different application (“Application B”) owned by the same customer as the application 214. Thus, on the graph 802, multiple lines may be used to depict data for multiple applications.

The x-axis is a predetermined date range. A user input 806 may be used to specify the predetermined date range.

The y-axis is a number of events (e.g., installs, clicks, in-app events, and the like). A user input 810 may be used to select the type of event. For example, the user input 810 may allow the user to select “installs,” “clicks,” or “events.”

A user input 808 may be used to select “publishers,” “organics,” or “totals.” If “publishers” is selected, only events attributable to an advertisement provider will be included in the graph 802. If “organics” is selected, only events not attributable to an advertisement provider will be included in the graph 802. If “totals” is selected, all events will be included in the graph 802.

In FIG. 11B, “publishers” has been selected in the user input 808, and “installs” has been selected in the user input 810. Thus, the line 804A depicts a number of installs of the application 214 from April 10 to April 17 that were attributed to one of the application providers. The graph 802 may be used to evaluate the overall effectiveness of an advertising campaign.

The reports page 224 includes an area 820 in which information about each of the applications owned by the customer may be displayed. In this example, buttons or links are associated with each application. The customer may select the buttons or links to view more information about each application. In FIG. 11B, the buttons include a publishers button 821, a campaigns button 822, and an organic button 823. When one of these buttons is clicked, a new table or graph (not shown) will be displayed that may help the customer evaluate (1) the effectiveness of particular publishers with respect to getting users to download the application, (2) the effectiveness of particular campaigns, and/or (3) the number of applications that are downloaded organically.

The reports page 224 includes a performance graph 830 and a budget graph 832. The graphs 830 and 832 may be used to show total customer numbers for all of the customer's applications. For example, the performance graph 830 may be used to depict a total number of clicks and installs the customer is experiencing for all of its applications over the predetermined date range. The budget graph 832 may be used to depict a payout amount and an amount of DGMrevenue generated by all of the customer's applications over the predetermined date range. The graphs 830 and 832 may help provide an overview of how well the customer is doing overall.

Returning to FIG. 1, as explained above, the system 100 may be used to track end user downloads of software applications. Further, the system 100 may be used to track end user actions within an installed software application. The system 100 may also be used to provide statistics and/or analytic to the Advertisers/Merchants 130, the Mobile Advertising Networks 140, and/or the Mobile Publishers 150 for the purpose of measuring the effectiveness of advertising campaigns.

### Computing Device

FIG. 12 is a diagram of hardware and an operating environment in conjunction with which implementations of the one or more computing devices of the system 100 may be practiced. The description of FIG. 12 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 12 includes a general-purpose computing device in the form of the computing device 12. Each of the computing devices of FIGS. 1 and 2A-2D (including the computing devices 122, 132, 142, 152, 162, 172, and 242) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface. The user interface is configured to display portions of the management interface (e.g., the tracking link page 222 illustrated in FIG. 11A, the reports page 224 illustrated in FIG. 11B, and the like) to the End Users 160.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 12 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 200, 250, 290, 300, 400, 600, 700, 430, 500, and 550 illustrated in FIGS. 3, 4, 5, 6A, 6B, 7A, 7B, 8, 9, and 10, respectively) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1. A method for use with an end user computing device, the method comprising:
generating, by a computing device of a tracking system, a tracking link;
sending, by a computing device of the tracking system, the tracking link to an advertiser to be embedded in an advertisement created by the advertiser, the advertisement associated with a software application;
receiving, by a computing device of the tracking system, user click information from the end user computing device, the user click information indicating that a user has selected the advertisement, the user click information comprising first device information and identifying an advertisement provider from which the end user computing device obtained the advertisement;
storing, by a computing device of the tracking system, the user click information;
receiving, by a computing device of the tracking system, application installation information from the end user computing device, the application installation information indicating that the user has installed the software application, the application installation information comprising second device information;
matching, by a computing device of the tracking system, the application installation information with the stored user click information based at least in part on the first and second device information; and
assigning, by a computing device of the tracking system, a credit for the installation of the software application by the user to the advertisement provider;
wherein the advertiser, the advertisement provider, and the end user computing device are each separate from the tracking system.

2. The method of claim 1, further comprising:
after the user click information is received, directing the end user computing device to an application provider computing device, the software application being available for download and installation from the application provider computing device.

3. The method of claim 2,
wherein the tracking link identifies an address of the application provider computing device to which the end user computing device is directed.

4. The method of claim 2, wherein the application installation information is received from the end user computing device after the end user computing device downloads the software application from the application provider computing device, installs the software application, and executes the software application for a first time.

5. The method of claim 1, further comprising:
sending a tracking identifier to the software application;
receiving event information from the end user computing device indicating that an in-application event has occurred within the software application, the event information including the tracking identifier; and
assigning a credit for the occurrence of the in-application event to the advertisement provider.

6. The method of claim 1, wherein the user click information is first user click information, the advertisement is a first advertisement, the advertisement provider is a first advertisement provider, and the method further comprises:
receiving second user click information from the end user computing device after having received the first user click information, the second user click information indicating that the user has selected a second advertisement associated with the software application, the second user click information comprising third device information and identifying a second advertisement provider different from the first advertisement provider from which the end user computing device obtained the advertisement;
storing the second user click information;
receiving event information from the end user computing device indicating that an in-application event has occurred within the software application, the event information including fourth device information; and
identifying the second user click information as a most recently received user click information associated with both the user and the software application based at least in part on the third and fourth device information;
in response to determining that re-engagement is enabled, assigning a credit for the occurrence of the in-application event to the second advertisement provider identified in the second user click information; and
in response to determining that re-engagement is not enabled, assigning a credit for the occurrence of the in-application event to the first advertisement provider identified in the first user click information.

7. The method of claim 1, wherein matching the application installation information with the stored user click information based at least in part on the first and second device information comprises determining the first and second device information each comprise an identical device identifier.

8. A method performed by at least one computing device of a tracking system with access to a plurality of user click records, the method comprising:
receiving, by the at least one computing device, application installation information indicating that a user has installed a software application, the application installation information comprising device information;
searching, by the at least one computing device based on first search criteria, the user click records for a user click record that matches the application installation information, wherein each user click record represents a click on a tracking link generated by the tracking system, wherein each user click record comprises device information and identifies an advertisement provider from which an end user obtained an advertisement associated with the software application, and wherein the tracking link was embedded in the advertisement by an advertiser that created the advertisement; and
in response to locating a matching user click record based on the first search criteria, assigning, by the at least one computing device, a credit for the installation of the software application by the user to the advertisement provider identified in the matching user click record;
wherein the advertiser and the advertisement provider are each separate from the tracking system.

9. The method of claim 8, further comprising:
if the search locates multiple matching user click records, assigning a credit for the installation of the software application by the user to the advertisement provider identified in a most recently created one of the multiple matching user click records.

10. The method of claim 8, further comprising:
if the search fails to locate a matching user click record, recording the installation of the software application by the user as an organic installation.

11. The method of claim 8, further comprising:
if the search fails to locate a matching user click record, searching the user click records for a matching user click record based on second search criteria that is different from the first search criteria; and
if the search conducted using the second search criteria locates a matching user click record, assigning a credit for the installation of the software application by the user to the advertisement provider identified in the matching user click record.

12. The method of claim 11, further comprising:
if the search conducted using the second search criteria fails to locate a matching user click record, recording the installation of the software application by the user as an organic installation.

13. The method of claim 8, wherein the first search criteria requires that the device information of the matching user click record match the device information of the application installation information.

14. The method of claim 13, wherein the device information of the matching user click record, and the device information of the application installation information each comprises a device identifier value, and
the first search criteria requires that the device identifier value of the matching user click record match the device identifier value of the application installation information.

15. The method of claim 14, wherein the device identifier value of the matching user click record and the application installation information comprises at least one of an Identifier for Advertising (“IFA”) value, a media access control (“MAC”) address value, and an Android ID value.

16. The method of claim 13, wherein the first search criteria further requires that the matching user click record was created within a predetermined lookback period.

17. The method of claim 13, further comprising:
if the search locates a matching user click record, sending a tracking identifier to the software application;
receiving event information indicating that an in-application event has occurred within the software application, the event information including the tracking identifier; and
assigning a credit for the occurrence of the in-application event to the advertisement provider identified in the matching user click record.

18. The method of claim 8, further comprising:
receiving event information indicating that an in-application event has occurred within the software application, the event information including device information;
searching, based on second search criteria, the user click records for one or more event matching user click records that match the event information;
in response to determining that re-engagement is enabled, assigning a credit for the occurrence of the in-application event to the advertisement provider identified in a most recently created one of the one or more event matching user click records; and
in response to determining that re-engagement is not enabled, assigning a credit for the occurrence of the in-application event to the advertisement provider identified in the user click record that matches the application installation information.

19. The method of claim 18, wherein the second search criteria requires that at least a portion of the device information of the matching user click record match at least a portion of the device information of the event information.

20. A method for use with a first client computing device associated with an advertiser and a second client computing device associated with an end user, the method being performed by at least one server computing device of a tracking system connected to the first and second client computing devices by a network, the method comprising:
receiving, by the at least one server computing device, a request for a tracking link from the first client computing device;
transmitting, by the at least one server computing device, the tracking link to the first client computing device, the tracking link identifying an advertisement provider and a destination address on the at least one server computing device, the tracking link being configured to be embedded in an advertisement created by the first client computing device and displayable on the second client computing device after being received from the advertisement provider, the advertisement being configured to be selectable by a user of the second client computing device and when selected, to direct the second client computing device to the destination address;
obtaining, by the at least one server computing device, device information when the second client computing device visits the destination address;
storing, by the at least one server computing device, the device information and an identification of the advertisement provider in a user click record associated with the advertisement in which the tracking link was embedded; and
directing, by the at least one server computing device, the second client computing device to a different address whereat the software application may be downloaded and installed on the second client computing device;
wherein the advertiser, the advertisement provider, and the end user are separate from the tracking system.

21. The method of claim 20, wherein the tracking link comprises one or more macros that, when the advertisement is selected, cause the second client computing device to collect the device information that is obtained by the at least one server computing device when the second client computing device visits the destination address.

22. The method of claim 20, wherein the device information is first device information, and the method further comprises:
receiving application installation information from the second client computing device indicating that the software application has been installed on the second client computing device, the application installation information comprising second device information;
matching the application installation information with the stored user click record based at least in part on the first and second device information; and
assigning a credit for the installation of the software application on the second client computing device to the advertisement provider identified by the user click record.

23. A method for use with a plurality of client computing devices, one or more advertisement provider computing devices, and a tracking system, the method being performed by a customer computing device connected to the plurality of client computing devices, the one or more advertisement provider computing devices, and the tracking system by a network, the method comprising:
sending, by the customer computing device, a request for a tracking link to the tracking system;
in response to the request, receiving the tracking link from the tracking system by the customer computing device, the tracking link identifying a destination address, and a selected advertisement provider associated with at least one of the one or more advertisement provider computing devices, the destination address being located on either the tracking system or the at least one advertisement provider computing device associated with the selected advertisement provider;
embedding, by the customer computing device, the tracking link in an advertisement associated with a software application, the advertisement being displayable by at least one of the client computing devices after being received by the at least one client computing device from the at least one advertisement provider computing device, and when so displayed, selectable by a user of the client computing device, the client computing device being directed to the destination address whenever the advertisement is selected by the user of the client computing device, the tracking system recording that the advertisement was selected each time one of the client computing devices is directed to the destination address;
transmitting, by the customer computing device, the advertisement to the at least one advertisement provider computing device associated with the selected advertisement provider, the at least one advertisement provider computing device being configured to transmit the advertisement to the client computing devices; and
sending, by the customer computing device, a request to the tracking system for a report indicating how many times the advertisement has been selected by the client computing devices over a predetermined period of time;
wherein the plurality of client computing devices, the one or more advertisement provider computing devices, and the customer computing device are all separate from the tracking system.

24. The method of claim 23, wherein the tracking link comprises one or more macros that cause the client computing devices to gather device information when the advertisement is selected, and provide that device information to whichever of the tracking system and the at least one advertisement provider computing device associated with the selected advertisement provider on which the destination address is located.

25. The method of claim 23, wherein the tracking link is a first tracking link, the advertisement is a first advertisement, the selected advertisement provider is a first advertisement provider, the destination address is a first destination address, and the method further comprises:
sending a request for a second tracking link to the tracking system;
in response to the request, receiving the second tracking link from the tracking system, the tracking link identifying a second destination address, and a second advertisement provider associated with at least one of the one or more advertisement provider computing devices, the second destination address being located on either the tracking system or the at least one advertisement provider computing device associated with the second advertisement provider;
embedding the second tracking link in a second advertisement associated with the same software application, the second advertisement being displayable by at least one of the client computing devices after being received by the at least one client computing device from the at least one advertisement provider computing device associated with the second advertisement provider, and when so displayed, selectable by the user of the client computing device, the client computing device being directed to the second destination address whenever the second advertisement is selected by the user of the client computing device, the tracking system recording that the second advertisement was selected each time one of the client computing devices is directed to the second destination address;
transmitting the second advertisement to the at least one advertisement provider computing device associated with the second advertisement provider, the at least one advertisement provider computing device that receives the second advertisement being configured to transmit the second advertisement to the client computing devices; and
sending a request to the tracking system for a report indicating how many times the second advertisement has been selected by the client computing devices over a predetermined period of time.

26. The method of claim 23, further comprising:
receiving a notification from the tracking system each time the advertisement is selected by the user of one of the client computing devices.

27. The method of claim 23, wherein the software application is configured to notify the tracking system when the software application has been installed and executed for a first time on one of the client computing devices, and the method further comprises:
sending a request to the tracking system for a report indicating how many times the software application has been installed and executed for the first time on one of the client computing devices over the predetermined period of time.

28. The method of claim 23, wherein the software application is configured to notify the tracking system when the software application has been installed and executed for a first time on one of the client computing devices, and the method further comprises:
receiving a notification from the tracking system each time the software application is installed on one of the client computing devices.
